(19) United States
(12) Patent Application Publication
(10) Pub. No.: US 2010/0154719 A1
(43) Pub. Date: Jun. 24, 2010

(54) Structure and method for entertaining a feline

(75) Inventors: Adam M. Kellogg, Oconomowoc, WI (US); Kelly C. Kellogg, Oconomowoc, WI (US); Dean B. Krotts, Hartland, WI (US)

Correspondence Address: RYAN KROMHOLZ & MANION, S.C., POST OFFICE BOX 26618, MILWAUKEE, WI, 53226, US

(73) Assignee: SportPet Designs, Inc.

(21) Appl. No.: 12/317,015

(22) Filed: Dec. 18, 2008

(51) Int. Cl. A01K 15/02

(52) U.S. Cl. 119/706; 119/702; 119/707

(57) ABSTRACT

Provided is a multi-configurable feline play structure having a plurality of modular components, modular components, and methods for joining modular components. Tubular frame members are joined by connectors, thereby forming a modular component. Each connector has a plurality of bores, each one of which is adapted to receive an end of a selected frame member. The connectors further connect multiple modular components to form a feline play structure. Flexible web members may be suspended from selected frame members, to form sides. Appurtenance in the form of playthings may be attached at various locations on the play structure such that many modular configuration combinations are available to the pet owner. A kit for a selected modular component may be formed comprising frame members, connectors, flexible webs, and assembly instructions.

### BACKGROUND OF THE INVENTION

The housecat is a popular pet due to its intelligence and personality. An owner's physical. household and the surrounding yard are shared with the cat and form the cat's territory. The responsibility attached to cat ownership includes providing the animal with proper nutrition, shelter, and interaction. As a result, various structures have been designed with pet housing or play in mind. Such structures may include an enclosed area which satisfies an animal's desire to “nest”, with more elaborate structures further including other specified areas, such as play areas with toys, or areas to satisfy an animal's need to rest, play, climb and watch.

Such complex playhouse structures seek to combine a layout that is appealing to pets while having design versatility. However, these structures are often difficult to move and/or store, particularly if the structure is large and includes a complex roof design. Furthermore, such structures typically have finite, stagnant configurations that are not able to be reconfigured, modified, or enlarged.

Accordingly, there is a need for a feline play structure that overcomes the above noted shortcomings.

### SUMMARY OF THE INVENTION

The present invention satisfies such a need by providing a feline play structure comprised of a plurality of interchangeably connectable modular units and kits, each one of which may be designed to provide a separate function. The user may easily assemble the units and reposition them as desired relative the multi-configurable play structure, with minimal tool use. Each modular unit is designed to provide a distinct function, such providing a nesting area, an amusement area, a lookout perch, a climbing structure, or any other area that may entertain a pet, such as a cat. The versatility of such an interchangeably connectable modular feline play structure provides a practical and inexpensive accessory for owners of such pets to keep them occupied while the owner is away, yet allow for infinite variety of configuration. A customizable, easy-to-assemble, feline playhouse according to the present invention is formed from modular components that may be purchased separately in kit form and assembled by the end user to form an individualized playhouse. Other features, such as toys and scratching posts may be added as well.

A feline play structure according to the present invention is adapted to be assembled by the user and may be used indoors or outdoors while providing a pet with exercise and playful enjoyment.

In view of the foregoing background, it is therefore an object of the present invention to provide a play structure for entertaining small animals, the structure having a plurality of interchangeably connectable modular units, each of the units having a configuration to promote a specific animal activity.

These and other features and advantages of the invention are provided by a play structure including a plurality of interconnecting, interchangeable units which are adapted to be releasably secured to one another.

### BRIEF DESCRIPTION OF THE DRAWINGS

FIG. 1 is a perspective view of a feline play structure according to the present invention with a plurality of completed modular structures joined together.

FIG. 2 is a perspective view of a feline play structure according to the present invention and showing an alternative arrangement of completed modular units joined together.

FIG. 3 is a perspective view of a nesting type modular unit.

FIG. 4 is a perspective view of an alternative embodiment nesting type modular unit and showing tab fasteners.

FIG. 5 is a perspective view of another modular unit to be used with the present invention.

FIG. 6 is a perspective view of the modular unit illustrated in FIG. 5, but showing tab fasteners.

FIG. 7A is a perspective view of an embodiment of a connector according to the present invention.

FIG. 7B is a side view of the connector shown in FIG. 7A.

FIG. 7C is a cross sectional view of the connector shown in FIG. 7A and taken along lines 7C-7C thereof.

FIG. 7D is a side view of an alternative connector and showing oppositely disposed, laterally extending collar portions.

FIG. 8 is an exploded view of the unit illustrated in FIG. 3 and showing the tubular frame components and connectors.

FIG. 9 is a perspective view of yet another modular unit to be used with the present invention.

FIG. 10 is a perspective view of the modular unit illustrated in FIG. 9, but showing tab fasteners.

FIG. 11 is a perspective view of a scratching post unit that may be used with the present invention.

FIG. 12 is a perspective view of a swat play unit to be used with the present invention.

FIG. 13 is a perspective view of the disassembled components of the modular unit illustrated in FIG. 3, which may be provided in kit form.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

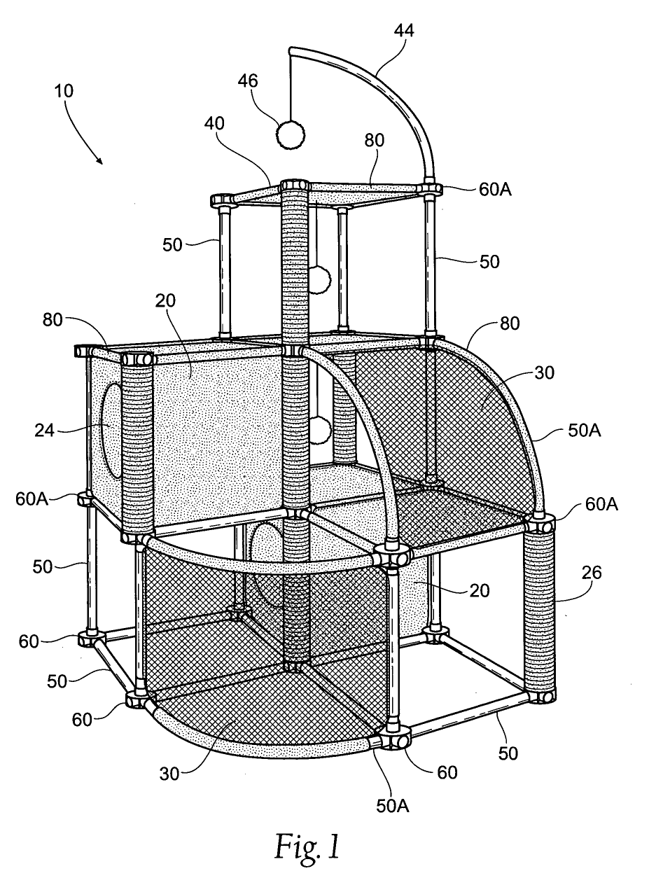

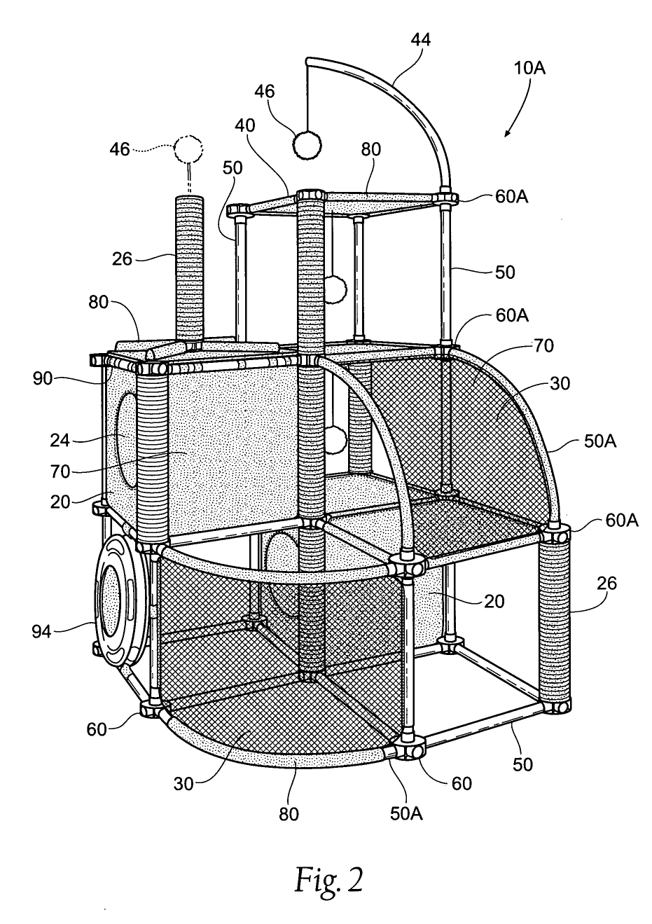

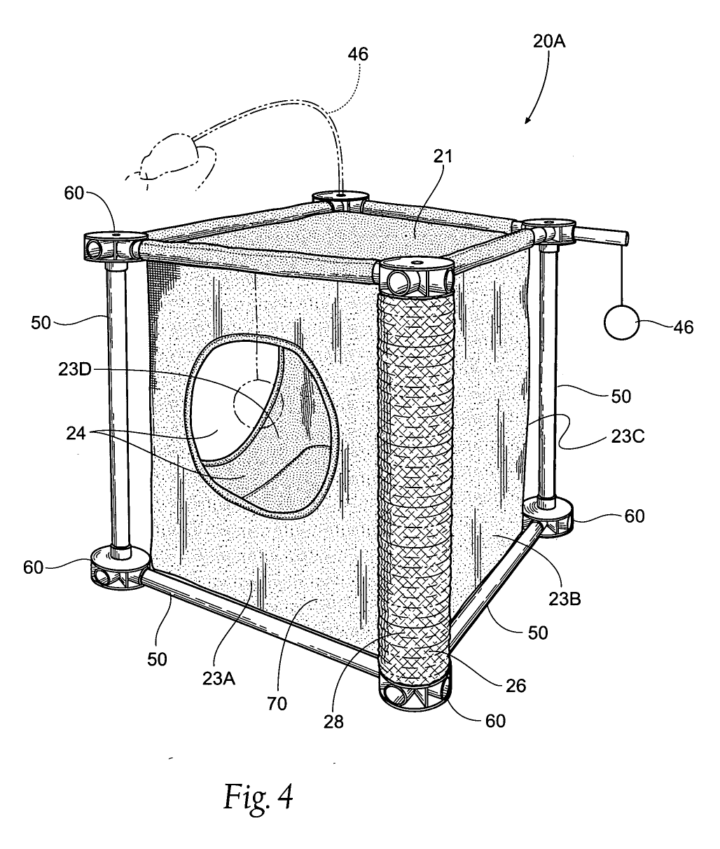

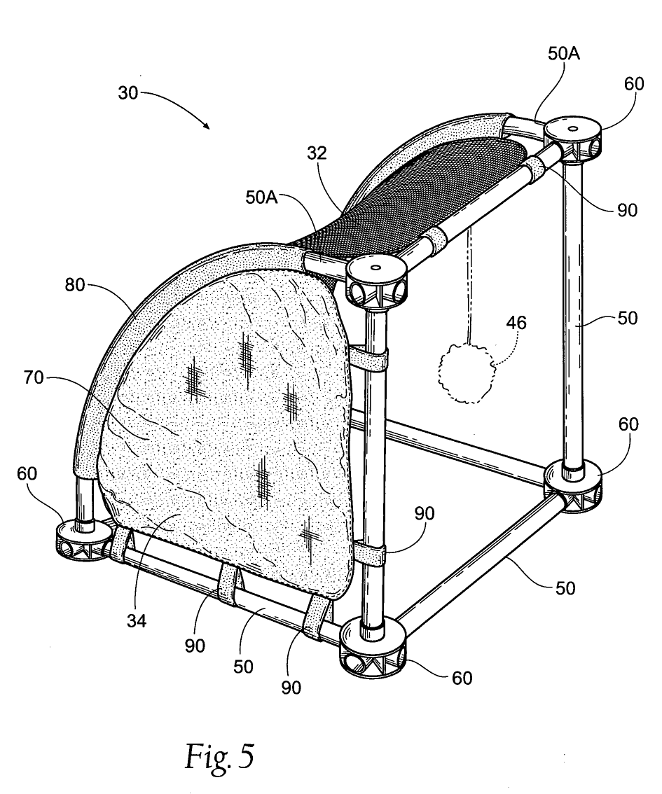

With reference to FIGS. 1 and 2, completed feline play structures 10, 10A according to the present invention are illustrated by way of non-limiting example. As viewed particularly in FIG. 1, the play structure 10 shown is configured as having a plurality of modular components 20, 30, 40. As seen, the modular components 20, 30, 40 each comprise a plurality of frame members 50, with modular component 30 having a plurality of curved frame members 50A (see also FIG. 5). As will be discussed in more detail, the frame members 50 or 50A are joined by way of connectors 60, 60A, with flexible webs 70 suspended from selected frame members 50, 50A of components 20, 30, and 40. Webs 70 may be made from any suitable material, such as nylon fabric, or mesh, for example. As shown the Figures, means for suspending the flexible webs 70 from frame members 50, 50A may be way of a sleeve 80 formed in a perimeter of a web 70, or by other means such as the tab member 90 illustrated in FIGS. 4, 6, and 10, or any combination thereof. The tab members 90 shown may be joined to the perimeter of a selected web 70 by sewing or other means, with the tab member 90 being selectively engageable with itself by way of a fastening mechanism 91, such as the hook and loop fastener shown.

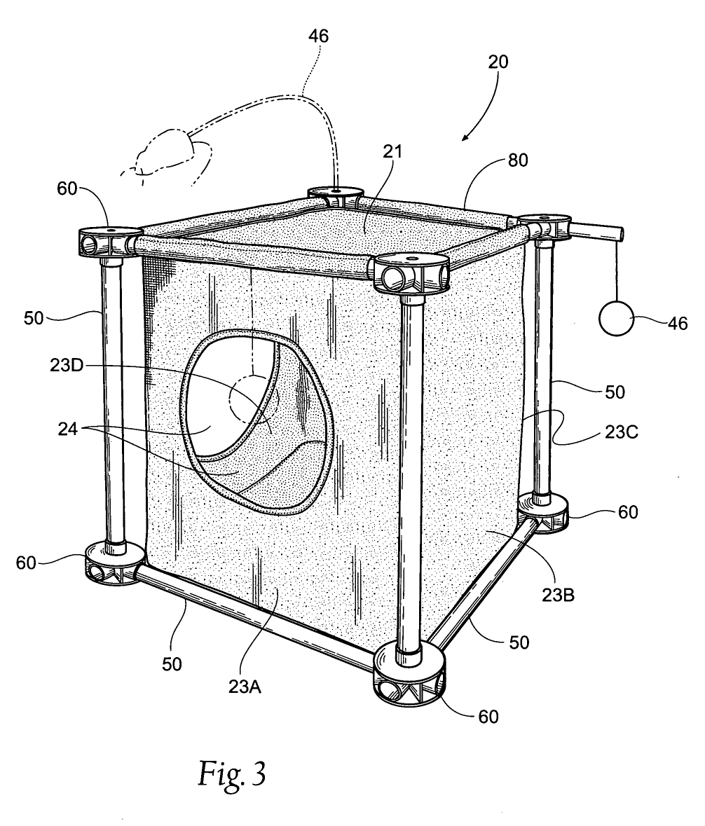

With reference now to FIG. 3, a modular hideaway unit 20 is shown. As illustrated, the modular hideaway unit 20 is designed to provide a hideaway or nesting environment for a selected animal, such as a cat (not shown). The modular hideaway unit 20 preferably comprises a plurality of straight tubular frame members 50, with the frame members 50 being joined by way of connectors 60. As discussed earlier, means for suspending the flexible webs 70 may be by way of a sleeve 80 formed in a perimeter of a selected web 70, or by other means such as the tab members 90 illustrated in FIG. 4, or any combination thereof. AS mentioned, the tab members 90 illustrated in FIG. 4 may be joined to the perimeter of a selected web 70 by sewing or other means, with a selected tab member 90 being selectively engageable with itself by way of a fastening mechanism, such as the hook and loop fastener shown. It is to be understood that a modular hideaway unit 20, 20A may be made having sleeve 80, tab member 90, or any combination thereof.

As may be further seen in FIGS. 3 and 4, the modular hideaway unit 20, 20A preferably includes a top panel 21, a bottom panel 22, and a plurality of adjacent side panels 23A, 23B, 23C, and 23D. AS illustrated in FIGS. 3 and 4, at least one of the panels 21, 22, 23A, 23B, 23C, 23D preferably includes at least one opening 24. Opening 24 provides access into the hideaway unit 20, 20A to thereby allow an animal to readily travel into and out of the hideaway unit 20, 20A.

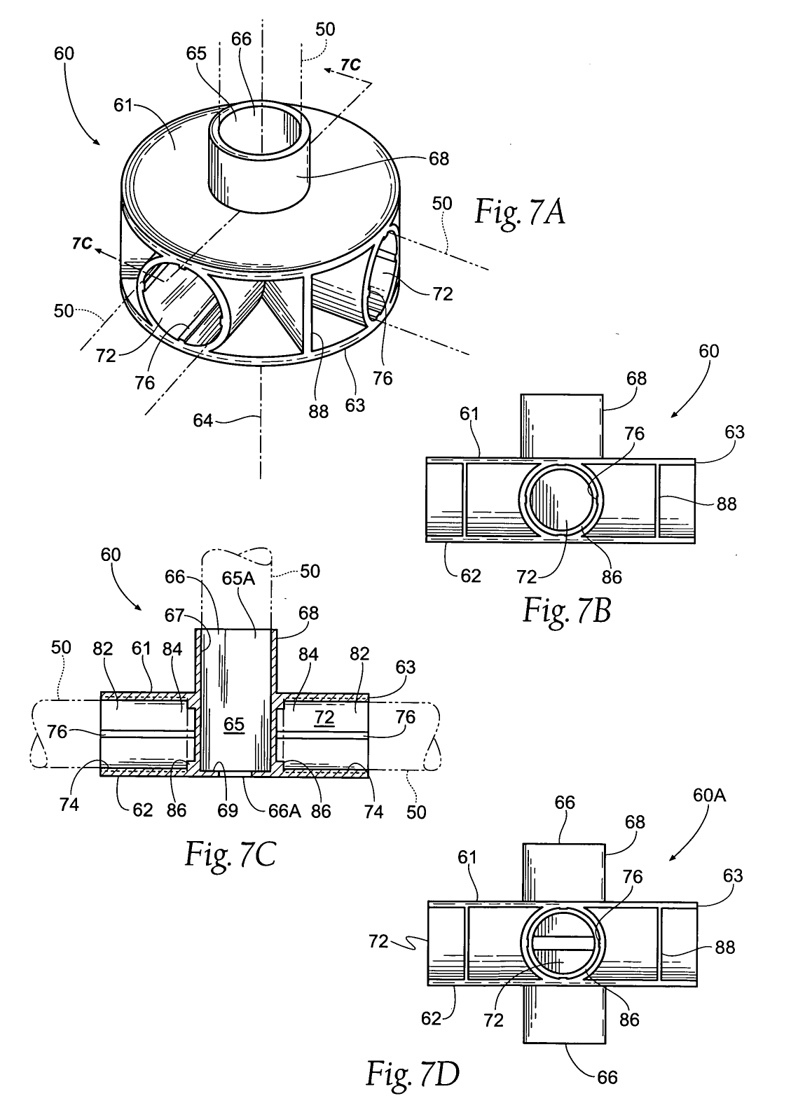

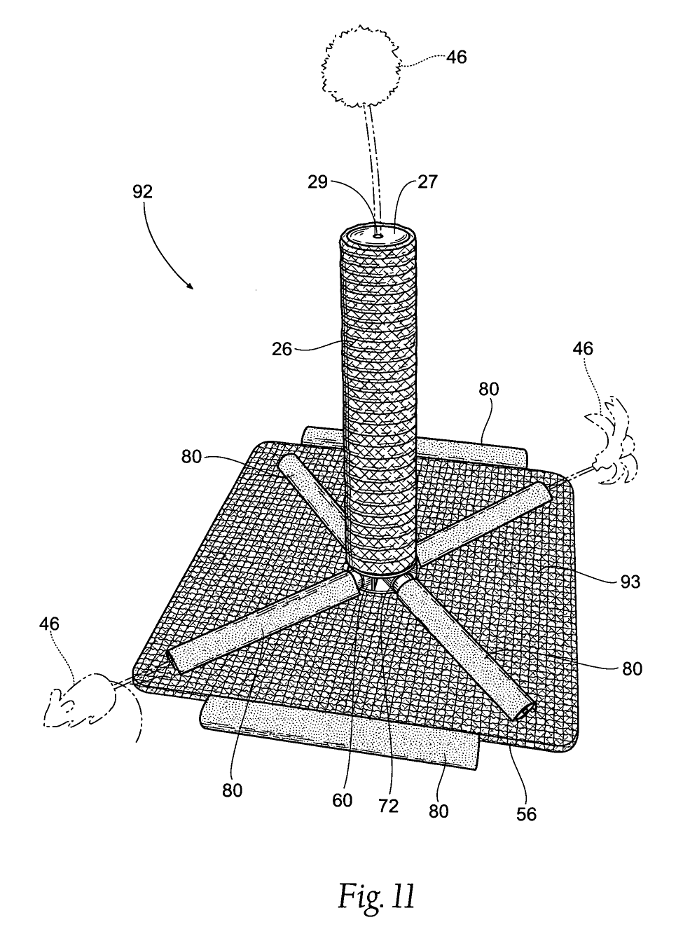

As viewed particularly in FIG. 4, the hideaway unit 20, 20A may further include a tubular frame member 50 having a scratching post 26. Since many cats (not shown) have a habit of standing on their hind legs and using their front paws to scratch any convenient object, the addition of a scratching post as a component of the hideaway unit 20, 20A encourages the cat (not shown) to indulge in its scratching habit, keep its claws in good condition and further encourage exercise through stretching. As illustrated, the scratching post 26 includes a cylindrical frame 27 having an opening 29 therein (see FIG. 7), and an outer covering 28 made of a suitable material. The frame 27 may be adapted to cover and be supported by a selected frame member 50 or alternatively, the cylindrical frame 27 opening 29 may be fit directly to selected connectors 60 or 60A, such that the scratching post 26 itself may substitute for a frame member 50. The outer covering 28 may be fabricated from any material that is both appealing to the cat and resistant to the destructive force of scratching. Such material may be sisal or other rug-like material, by way of non-limiting example. Alternatively, and as seen in FIG. 11, a play structure according to the present invention may provide a scratching post 26 as a separate play component 92. Appurtenance in the form of playthings, such as the batting toys 46 shown, may be attached at various locations on the hideaway unit 20, 20A.

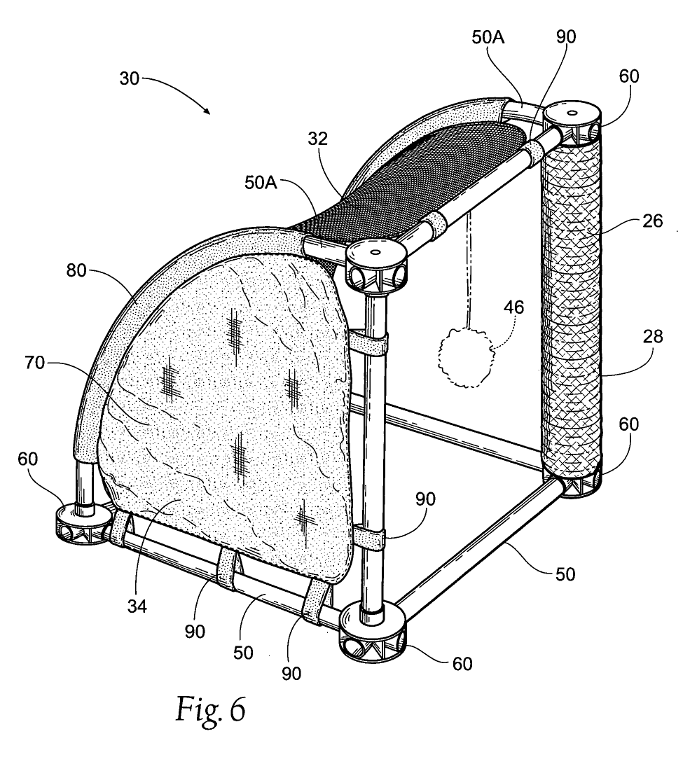

With reference now to FIGS. 5 and 6, a modular climbing hill unit 30 is shown. As illustrated, the modular climbing hill unit 30 is designed to provide a climbing environment for a selected animal, such as a cat (not shown). The modular climbing hill unit 30 preferably comprises a plurality of straight tubular frame members 50 and a plurality of curved frame members 50A, with the frame members 50, 50A being joined by way of connectors 60, 60A. As discussed earlier, and as shown in FIGS. 5 and 6, means for suspending the flexible webs 70 from frame members 50, 50A may be by way of a sleeve 80 formed in a perimeter of a web 70, or by other means such as a tab member 90, or any combination thereof. As in the modular unit 20, 20A illustrated in FIGS. 3 and 4, the tab members 90 illustrated in FIGS. 5 and 6 may be joined to the perimeter of a selected web 70 by sewing or other means, with the tab member 90 being selectively engageable with itself by way of a fastening mechanism, such as the hook and loop fastener shown. It is to be understood that a modular climbing hill unit 30 may be made having a sleeve 80, tab member 90, or any combination thereof, as a web suspension means.

As may be further seen in FIGS. 5 and 6, the modular climbing hill unit 30 preferably includes a curved top panel 32, suspended by curved frame members 50A, and at least one side panel 34. It is to be understood that while the Figures depict a modular climbing hill unit 30 having one side panel 34, any number of side panels 34 may be provided without departing from the spirit of the invention. A bottom panel (not shown) may also be provided, depending on the vagary of the end user. Similar to the previously described hideaway unit 20, 20A, a climbing hill unit 30 may further include a tubular frame member 50 having a scratching post 26. As discussed earlier, since many cats (not shown) enjoy using their front paws to scratch any convenient object, the addition of a scratching post as a component of the climbing unit 30, 30A encourages a cat (not shown) to indulge in its scratching habit, keep its claws in good condition and further encourages exercise through stretching. As previously seen, and as illustrated in FIG. 6, the scratching post 26 includes a cylindrical frame 27 having an opening 29 therein (see FIG. 7), and an outer covering 28 made of a suitable material. The frame 27 may be adapted to cover and be supported by a selected frame member 50 or alternatively, the cylindrical frame 27 opening 29 may be fit directly to selected connectors 60 or 60A, such that the scratching post 26 may substitute for a frame member 50. The outer covering 28 may be any material that is both appealing to the cat and resistant to the destructive force of scratching. Such material may be sisal or other rug-like material, by way of non-limiting example.

As mentioned with regard to the hideaway unit 20, 20A, the modular climbing hill unit may also be provided with appurtenance in the form of playthings, such as the batting toy 46, shown. It is to be understood that the playthings may be in any form attractive to felines.

FIGS. 7A, 7B, 7C, and 7D provide a connector 60, 60A, which may be formed in several desirable shapes, but is preferably formed generally in the shape of a compact cylinder having a top surface 61, a bottom surface 62, and a peripheral edge surface 63. As seen, a connector 60, 60A includes a central axis 64 extending from the top surface 61 to the bottom surface 62. The connector 60, 60A may further include an axially extending inner bore 65 adapted to receive an end 52 of a selected tubular frame member 50, 50A in opening 66. As seen, the bore 65 may be disposed preferably coaxially and extending from the top surface 61 to the bottom surface 62 of the connector 60, 60A, and include at least one bore opening 66. The bore 65 preferably has a relatively uniform diameter and includes inner surfaces 67 adapted to retain an end 52 of a selected frame member 50, 50A therein. As may be observed in FIGS. 7A-7D, the bore 65 may be extended by way of a laterally extending collar portion 68 that defines a substantially cylindrical, close-fitting channel 65A adapted to receive an end portion 52 of a selected tubular frame member 50, 50A therein. For greater flexibility in construction, and as seen in FIG. 7D, the bore 65 may include a pair of oppositely disposed, laterally extending collar portions 68, 68A. Use of a connector 50A as seen in FIG. 7D permits further connectivity options, such as may be observed in FIGS. 1 and 2.

As further seen in FIGS. 7A-7D, a connector 60, 60A according to the present invention may include a bore 65 having a first opening 66 and a second, oppositely disposed opening 66 having a diameter consistent with the first opening, as shown in FIG. 7D. Alternatively, a connector 60 may have a first opening 66 having a first diameter, and a second, coaxial opening 66A having a second, smaller diameter. It may be observed that a connector 60 including a second coaxial opening 66A having a second, smaller diameter, further thereby provides a ledge 69. The ledge 69 serves to limit longitudinal movement of an inserted tubular frame member 50, 50A, to thereby ensure proper fit and alignment of the various components during assembly of a selected modular component 20, 30, 40. Connectors 60 having this configuration may be used when a flat bottom surface 62 is desired, as for example when the bottom surface 62 is to be placed on the floor (not shown). The second opening 66A may further be used to support any number of feline playthings, including the batting toy 46, seen in phantom in FIG. 3, by way of non-limiting example.

As may be further observed with reference to FIGS. 7A-7D, a connector 60, 60A according to the present invention further includes a peripheral edge surface 63. The edge surface 63 may be provided with one or more radially extending bores 72. The radially extending bores 72 are preferably adapted to receive an end portion 52 of a selected frame member 50, 50A. While a connector 60, 60A according to the present invention may include any practical number of bores 72, a preferred number is four, wherein the spacing between adjacent bores 72 is approximately 90 degrees. This spacing permits the most accurate spacing of frame members and allows convenient connection of adjacent modular units 20, 30, 40, 40A, for example. As seen, an interior surface 74 of each bore 72 includes at least one raised area 76 that preferably comprises an inwardly directed, raised ridge 78 that compresses against the exterior 54 of an end 52 of a tubular frame member 50, 50A when the end 52 is inserted in the bore portion 72. Preferably, the height of the ridges 78 is sufficiently great to ensure that they will engage the exterior surface 54 of the end 52 of the tubular frame member 50, 50A, given the expected variations in frame member 50, 50A dimension and the manufacturing tolerances of the connector 60, 60A. As best seen in FIGS. 7A and 7C, the ridges 78 simply contact and slightly deform the frame member 50, 50A to a greater or lesser degree as needed to ensure a snug fit within the bore 72, regardless of minor variations in the actual clearance between a selected connector 60, 60A and a selected frame member 50, 50A. Preferably, one or more ridges 78 are formed on the interior surface 74 of each bore 72.

With particular reference to FIG. 7C, each radially extending bore 72 is further preferably provided with a proximal end 82 and a distal end 84, with the distal end 84 including an upstanding annular shoulder 86. Upstanding annular shoulder 86 limits longitudinal movement of a selected frame member 50, 50A as its end 52 is positioned within the bore 72. In this manner, each frame member 50, 50A is automatically directed into proper axial alignment with the connector 60, 60A as it is inserted into the bore 72.

The connectors 60, 60A are preferably formed of, or molded from, a polymeric material with some rigidity, such as plastic. Preferably, the connector structure 60, 60A is integrally formed, and the connector 60, 60A is molded as a unitary structure in a single manufacturing step. The connector 60, 60A may be provided with strengthening ribs 88 for added rigidity, if desired.

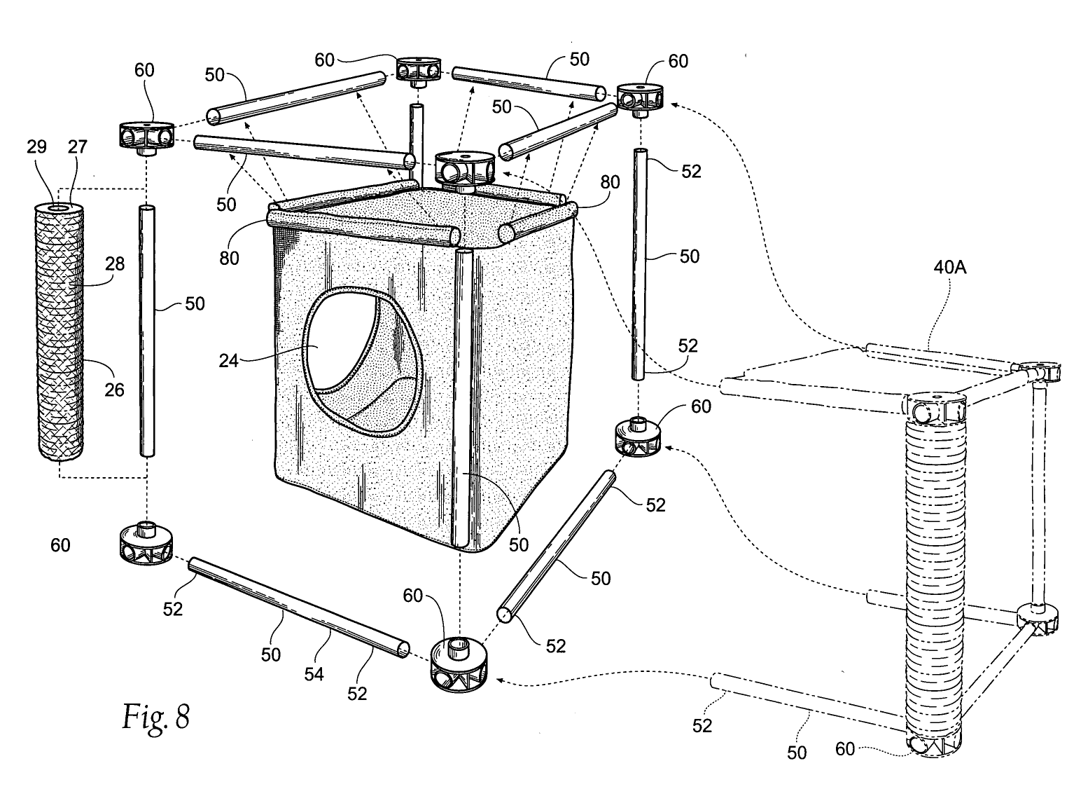

Turning now to FIG. 8, an exploded view of the modular hideaway unit 20A is shown to thereby illustrate the manner in which the cooperating components of a selected modular unit may be assembled and connected with other modular units to form a completed play structure 10.

First, a selected frame member 50, 50A is slidingly received into a sleeve 80 on web 70. As seen, at least one connector 60, 60A is provided to facilitate the interconnection of the various frame members. As previously mentioned, each connector 60, 60A preferably includes at least one axially extending inner bore 65 adapted to receive an end 52 of a selected tubular frame member 50, 50A in opening 66. Each connector 60, 60A may further include peripheral edge surface 63 provided with one or more radially extending bores 72 also adapted to receive an end portion 52 of a frame member 50, 50A. A selected end portion 52 of frame member 50 is inserted into a selected bore 65 or 72 of a connector 60, 60A. Multiple frame members 50, 50A are assembled in this manner to form the desired modular structure 20, 30, 40. With further reference to FIG. 8, the manner by which multiple modular components 20, 30, 40 may be interconnected to form a completed play structure may be seen in phantom. In a manner similar to that of an individual modular structure 20, 30, 40, the assembled or partially assembled modular structures may be connected to form a feline play structure comprised of a plurality of interchangeably connectable modular units. As illustrated, selected frame members 50, 50A of an adjacent modular unit 20, 30, 40 are coupled via connectors 60, 60A

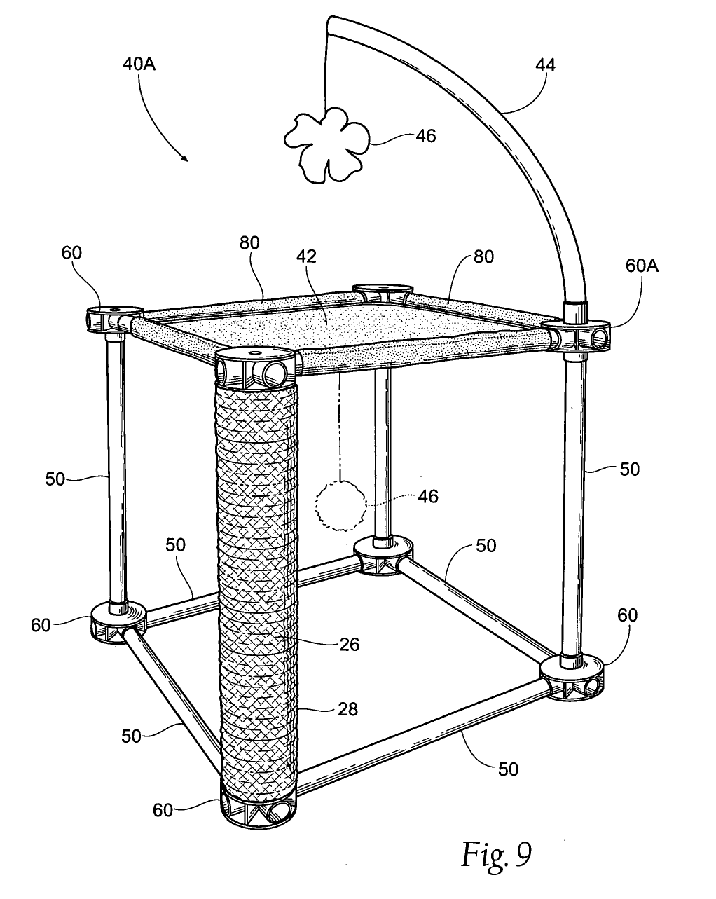

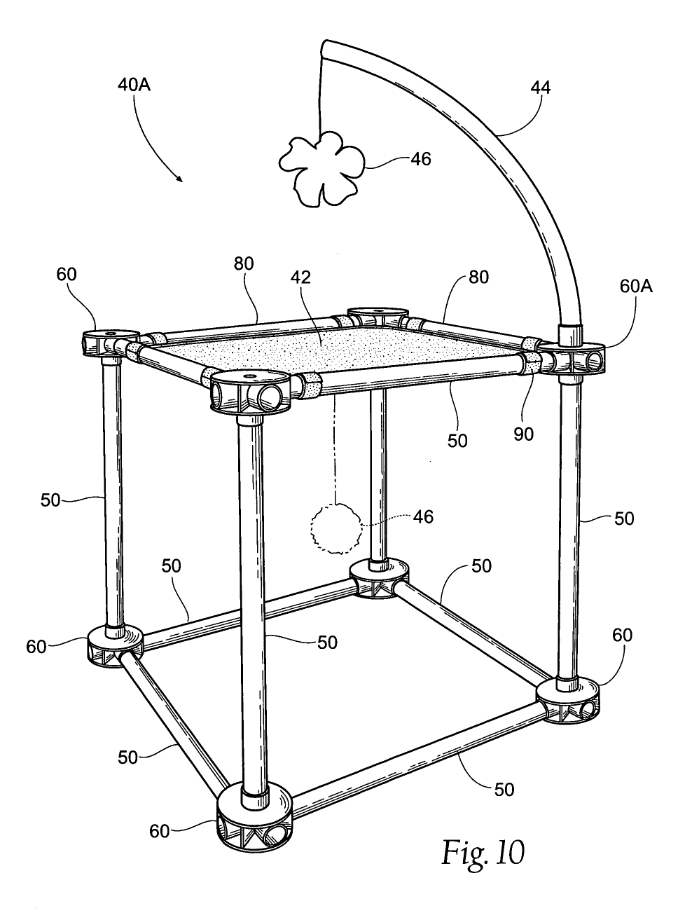

Referring now to FIGS. 9 and 10, a modular lookout unit 40 is shown. As illustrated, the modular lookout unit 40 is designed to provide an elevated location for a selected animal, such as a cat (not shown). The modular lookout unit 40 preferably comprises a plurality of straight tubular frame members 50, with the frame members 50 being joined by way of connectors 60, 60A. As discussed with regard to modular units 20 and 30, means for suspending flexible webs 70 from the frame members 50 may be by way of a sleeve 80 formed in a perimeter of selected webs 70, or by way of tab members 90. The tab members 90 illustrated in FIG. 10 may be joined to the perimeter of a selected web 70 by sewing or other means, with the tab member 90 being selectively engageable with itself by way of a fastening mechanism 91, such a hook and loop fastener. It is to be understood that a modular lookout unit 40 may be made having sleeve 80, tab member 90, or any combination thereof.

As may be further seen in FIGS. 9 and 10, the modular lookout unit 40 preferably includes at least a top panel 42, although it is within the scope the of the embodiment to include any number of side panels (not shown) without departing from the spirit of the invention. A bottom panel (not shown) may also be provided, depending on the configuration desired by an end user. As in the previously discussed modular units 20, 20A, 30, and 30A, the lookout unit 40, 40A may further provide a selected tubular frame member 50 with a scratching post 26 (see FIG. 9), or simply replace a frame member 50 with a scratching post 26. The lookout unit 40, 40A may be optionally provided with any number of appurtenances in the form of feline playthings, including the rod 44 and batting toy 46 or batting toy on string 46 (seen in phantom), by way of non-limiting example.

With reference to FIG. 11, modular play unit 92 is shown. As illustrated, the modular play unit 92 is designed to provide a scratching and play location for a selected animal. The modular play unit 92 preferably comprises a plurality of straight tubular frame members 50, with the frame members 50 being retained in radially extending bores 72 of connector 60. The frame members 50 are further retained on a support surface 93 by way of sleeves 80. The support surface 93 may retain the frame members 50 thereon by way of a sleeve 80 formed on the planar surface of the support surface 93. Alternatively, the frame members 50 may be retained on the support surface 93 by way of tab members 90 (not shown in these views). As previously discussed with reference to modular units 20, 20A, 30, and 30A, the tab members 90 may be joined to the planar surface support surface 93 by sewing or other means, with the tab member 90 being selectively engageable with itself by way of a fastening mechanism, such a hook and loop fastener. As may be further seen, the support surface 93 may include at least one sleeve 80 on peripheral edge 56. Providing the support surface 93 with a sleeve 80 on a peripheral edge 56 provides means for attaching the modular play unit 92 to a selected adjacent unit 20, 30, 40.

With further reference to FIG. 11, the modular play unit 92 preferably includes at least one planar support surface 93, although it is within the scope the of the embodiment to include any number of support panels (not shown) without departing from the spirit of the invention. As seen, a play unit 92 includes a scratching post 26 upstanding from the support surface 93. Similarly to those previously discussed, the scratching post 26 shown in FIG. 11, includes a cylindrical frame 27, and an outer covering 28 made of a suitable material, with frame 27 being adapted to receive a laterally extending collar portion 68 of a connector 60, 60A to thereby be supported thereon. Radially extending bores 72 of connector 60 each receive an end portion 52 of selected frame members 50, with the frame members 50 being further retained by sleeves 80 on support surface 93. The play unit 92 may be optionally provided with any number of feline playthings, 48 (seen in phantom), by way of non-limiting example.

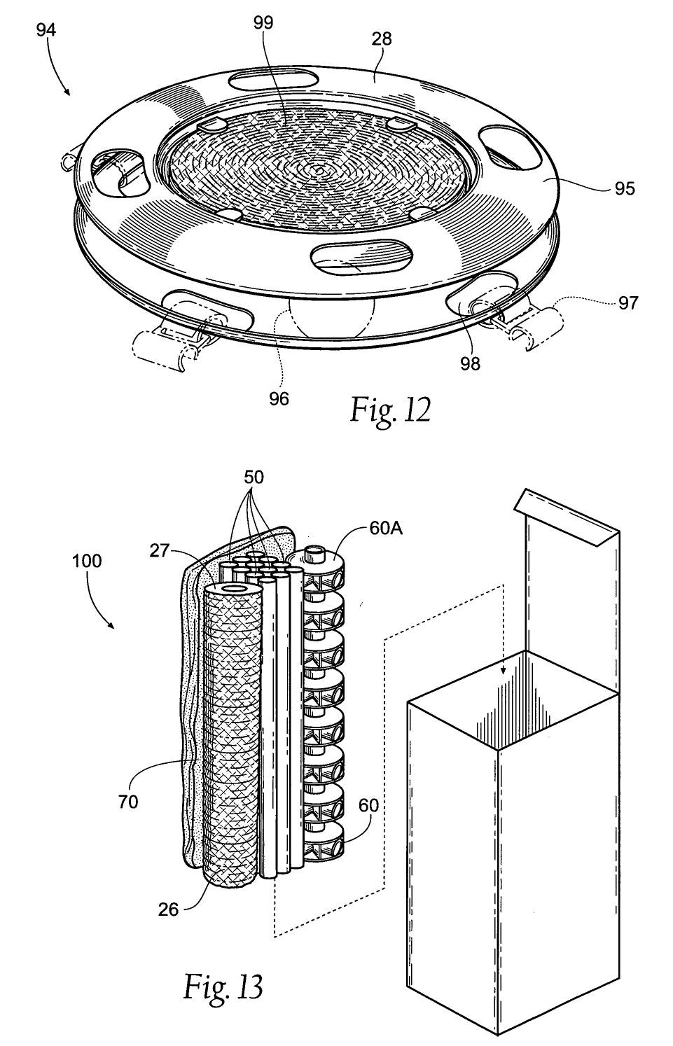

With reference now to FIG. 12, a modular swat play unit 94 is shown. As illustrated, the modular swat play unit 94 is designed to provide scratching and active play for a selected animal. The modular swat play unit 94 preferably comprises a disc-like track structure 95 adapted to receive and retain a ball 96 (shown in phantom). The structure 95 is further adapted for suspension from the frame members 50 of a selected adjacent modular unit 20, 30, 40 by way of the curved tab members 97 shown in phantom, or any structure adapted to engage selected frame members 50. The curved tab members 97 illustrated in FIG. 12 may be joined to the structure 95 by looping through apertures 98, with the curved tab member 97 being selectively engageable with itself by way of a fastening mechanism, such as a hook and loop fastener.

As may be further seen in FIG. 12, the modular swat-play unit 94 preferably includes a relatively planar top surface 99 having at least a portion thereof comprised of a scratching surface 28. Scratching surface 28 is preferably of similar composition to that described with regard to the scratching post 26, and is adapted for feline scratching or other play and is made of a suitable material that is both appealing to the cat and resistant to the destructive force of scratching. Sisal or other rug-like material is preferred.

FIG. 13 depicts disassembled modular structure component parts, which may be provided in kit 100 form for assembly. Dependent on the desired modular unit 20, 30, 40 to be assembled, a kit 100 may include a plurality of frame members 50, 50A, a plurality of connectors 60, 60A, and at least one web member 70. While kits 100 for assembly of other modular units herein described are not specifically illustrated, it is anticipated that any unit previously described may be provided in a kit form for assembly by the user. It is envisioned that any number of kits 100 may be purchased separately for assembly and interconnection with one another for creation of a feline play structure 10, 10A

A method according to the present invention includes providing a kit 100. The kit includes a plurality of frame members 50, a plurality of connectors 60, 60A, and at least one web member 70. Dependent on the desired final modular unit 20, 30, 40, to be assembled, a kit 100 may further include curved frame members 50A. The frame members 50, 50A are coupled to each other by way of the connectors 60, 60A to form the desired modular component 20, 30, 40. Dependent on the desired final modular unit, the kit may be provided with multiple flexible webs 70, which are adapted to be suspended from a selected frame member 50, 50A to form a selected panel 21, 22, 23A, 23B, 23C, 23D, 32, 34, or 42. A feline play structure 10, 10A may then be formed by positioning selected, assembled modular units 20, 30, 40 adjacent one another and coupling them to one another by way of adjacent connectors 60, 60A. To do so, the provided connectors 60, 60A and their bores 65 engage the ends 52 of the frame members 50, 50A of selected modular units 20, 30, 40 to thereby connect multiple modular units 20, 30, 40 adjacent one another to form a cohesive play structure 10.

In this manner a feline play structure 10 may be enlarged or reconfigured by simply connecting additional modular units 20, 30, 40 to one another so that a larger or alternatively configured structure 10 is provided.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A modular play structure for entertaining small animals, said play structure comprising a plurality of interchangeably connectable modular units, each of said modular units comprising:
a plurality of frame members;
a plurality of connectors, each one of said plurality of connectors being adapted to receive an end of a selected frame member; and
at least one web, said at least one web being provided with means for suspension from a selected one of said plurality of frame members.

2. The modular play structure of claim 1 wherein at least one of said plurality of frame members has a generally curved shape.

3. The modular play structure of claim 1 wherein said at least one web includes an aperture formed therein.

4. The modular play structure of claim 1 wherein said means for suspension includes a sleeve structure formed in an edge of said at least one web.

5. The modular play structure of claim 1 wherein said means for suspension includes a tab structure attached to an edge of said at least one web.

6. The modular play structure of claim 1 wherein at least one frame member further includes an outer covering comprised of a material adapted withstand feline scratching.

7. The modular play structure of claim 6 wherein said outer covering is a sisal material.

8. The modular structure of claim 6 wherein said outer covering is a rug material.

9. The modular structure of claim 1 wherein at least one of said plurality of connectors further includes a top surface, a bottom surface, and a peripheral edge surface.

10. The modular structure of claim 9 wherein said at least one of said plurality of connectors further includes a central axis extending from said top surface to said bottom surface and an axially extending inner bore having an opening adapted to receive an end of a selected frame member.

11. The modular structure of claim 10 wherein said inner bore extends from said top surface to said bottom surface.

12. The modular structure of claim 11 wherein said inner bore includes inner surfaces defining a uniform bore diameter.

13. The modular structure of claim 12 wherein said inner bore further includes a laterally extending collar portion, said collar portion defining a substantially cylindrical channel, said channel being adapted to receive an end portion of a selected frame member therein.

14. The modular structure of claim 13 wherein said inner bore includes a pair of oppositely disposed, laterally extending collar portions.

15. The modular structure of claim 14 wherein said inner bore includes a first opening and a second, oppositely disposed opening, and wherein said first and second openings have a diameter, said diameter being constant.

16. The modular structure of claim 14 wherein said inner bore includes a first opening and a second, oppositely disposed opening, and wherein said first opening has a first diameter, and said second, coaxial opening has a second, relatively smaller diameter.

17. The modular structure of claim 16 wherein said inner surface of said inner bore is further provided with an inwardly extending annular ledge structure.

18. The modular structure of claim 15 wherein said connector further includes a peripheral edge surface, said edge surface being provided with at least one radially extending bore adapted to receive an end portion of a selected frame member.

19. The modular structure of claim 18 wherein said connector includes four radially extending bores, each one of said bores being spaced from an adjacent bore by a 90 degree angle.

20. The modular structure of claim 18 wherein said at least one radially extending bore further includes an inner bore surface, said inner bore surface including at least one raised area.

21. The modular structure of claim 20 wherein said raised area comprises an inwardly directed, raised ridge member.

22. The modular structure of claim 1 further including at least one feline plaything.

23. The modular structure of claim 22 wherein said at least one feline plaything includes means for attachment to at least one of said plurality of interchangeably connectable modular units.

24. A connector adapted for use in a modular multi-configurable feline play structure system, the system having at least one frame member, said connector being adapted to receive an end of a selected frame member and including a top surface, a bottom surface, and a peripheral edge surface.

25. The connector of claim 24 further including a central axis extending from said top surface to said bottom surface and an axially extending inner bore having an opening therein.

26. The connector of claim 25 wherein said inner bore extends from said top surface to said bottom surface.

27. The connector of claim 26 wherein said inner bore includes inner surfaces defining a uniform bore diameter.

28. The connector of claim 27 wherein said inner bore further includes a laterally extending collar portion, said collar portion defining a substantially cylindrical channel, said channel being adapted to receive an end portion of a selected frame member therein.

29. The connector of claim 28 wherein said inner bore includes a pair of oppositely disposed, laterally extending collar portions.

30. The connector of claim 29 wherein said inner bore includes a first opening and a second, oppositely disposed opening, and wherein said first and second openings have a diameter, said diameter being constant.

31. The connector of claim 29 wherein said inner bore includes a first opening and a second, oppositely disposed opening, and wherein said first opening has a first diameter, and said second, coaxial opening has a second, smaller diameter.

32. The connector of claim 31 wherein said inner surface of said inner bore is further provided with an inwardly extending annular ledge structure.

33. The connector of claim 30 wherein said connector further includes a peripheral edge surface, said edge surface being provided with at least one radially extending bore adapted to receive an end portion of a selected frame member.

34. The connector of claim 33 wherein said connector includes four radially extending bores, each one of said bores being spaced from an adjacent bore by a 90 degree angle.

35. The connector of claim 33 wherein said at least one radially extending bore further includes an inner bore surface, said inner bore surface including at least one raised area.

36. The connector of claim 35 wherein said raised area comprises an inwardly directed, raised ridge member.

37. A method for entertaining a feline animal, including the steps of:
providing a modular play structure, said play structure comprising a plurality of interchangeably connectable modular units;
providing each of said modular units with a plurality of frame members;
providing each of said modular units with a plurality of connectors adapted to connect the frame members;
providing each of said modular units with at least one web, said at least one web being provided with means for suspension from a selected one of said plurality of frame members; and
introducing a feline animal to said play structure.

38. The method of claim 37 further including the step of providing at least one feline plaything, said at least one feline plaything including means for attachment to a selected one of said plurality of interchangeably connectable modular units.

39. A modular multi-configurable feline play structure system comprising:
plurality of interchangeably connectable modular units;
at least one of said plurality of modular units having a plurality of tubular frame members, each of said frame members including an end;
a plurality of connectors, each of said plurality of connectors being adapted to receive an end of said frame member;
at least one web, said at least one web being provided with means for suspension from a selected one of said plurality of frame members; and
at least one feline plaything adapted for attachment to a selected one of said plurality of modular units.
